(19) United States
(12) Patent Application Publication
(10) Pub. No.: US 2010/0064441 A1
(43) Pub. Date: Mar. 18, 2010

(54) HOSPITAL BED WITH ELECTRIC EMERGENCY LOWERING DEVICE

(76) Inventor: Hans-Peter Barthelt, Esslingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/531,631

(22) PCT Filed: Mar. 5, 2008
(86) PCT No.: PCT/EP08/01731

§ 371 Date: Sep. 16, 2009

(30) Foreign Application Priority Data
Mar. 16, 2007 (DE) 102007013354.7

(51) Int. Cl. A61G 7/015; A61G 7/012; A61G 7/018

(52) U.S. Cl. 5/616

(57) ABSTRACT

A hospital bed features a central control for operating the electric drives. To quickly lower the back section for reanimation purposes in case of an emergency, it is possible to select a special mode in which the motor for the back section is acted upon by a voltage that lies above the voltage acting upon the motor in the normal mode.

### CROSS-REFERENCE TO RELATED APPLICATIONS

This patent application is the national phase of PCT/EP2008/001731, filed Mar. 5, 2008, which claims the benefit of German Patent Application No. 102007013354.7, filed Mar. 16, 2007, both of which are herein incorporated by reference in their entireties for all that they teach without exclusion of any part thereof.

### FIELD OF THE INVENTION

The present invention relates generally to adjustable hospital beds, and in particular, relates to electrically adjustable hospital beds having a raisable upper portion that may be rapidly lowered to facilitate emergency services.

### BACKGROUND OF THE INVENTION

Many hospital beds have a movable upper portion that may be put in an inclined position if desired. However, to revive collapsed patients in the event of a cardiac arrest or other emergency, it is generally necessary to bring the upper part of the body back to a horizontal position. This should take place as quickly as possible. If the back section of the hospital bed is manually actuated, then returning the bed to a horizontal position is relatively unproblematic. However, the situation is more critical with hospital beds in which the rear section is driven by means of an electric motor, such that the back section can also be easily adjusted by the patient. The actuators used for this purpose are inherently self-locking or self-blocking such that the bed remains in the desired position when the power is off. The emergency lowering of the back section is thus more complicated.

Traditionally, to overcome this problem the gearing of the actuator was decoupled to neutralize the self-locking effect. In this case, other parts of the gearing still act as a brake. The back section is lowered at a speed that results from the weight of the patient and the residual friction in the gearing. If the patient is heavy, this may, under certain circumstances, lead to an abrupt lowering that must be counteracted accordingly by the hospital personnel. Lightweight patients, in contrast, may require hospital personnel to exert an additional manual force upon the back section. In either case, this mechanical lowering of the back section by disengaging the gearing is quite problematic.

Based on these circumstances, the invention aims to develop a new hospital bed in which the emergency lowering is achieved electrically.

### OBJECTS AND SUMMARY OF THE INVENTION

It is an object of the invention to provide a hospital bed in which the emergency lowering is achieved electrically.

It is a further object of the invention to provide a hospital bed having a lifter that stands on the floor and can be adjusted vertically. A bed frame with at least one adjustable back or upper section is situated on the lifter, wherein the back section may, if applicable, also contain a separate adjustable head section. At least the back section is moved by means of a motor drive. The motor drive designed for operation at a normal speed also enables handicapped patients to position the back section as desired.

It is further object of the invention to provide a hospital bed as described above, wherein a power supply with two operating states is assigned to the motor drive. One operating state is the normal operating state, in which the motor is actuated via a supply voltage that corresponds to normal operating speeds. The power supply can be changed over into an emergency mode. In emergency mode, the motor drive for the back section is actuated by a voltage that is significantly higher than the normal operating voltage, e.g., by a factor of 1.5 or 2. This makes it possible to lower the back section at very high speed in power-driven fashion in case of an emergency that requires resuscitation. The moving speed is essentially independent of the weight of the patient. Hospital personnel, in particular, need not intervene in moving the back section in terms of assistance or deceleration. The back section, rather, moves into the horizontal position in a fully-automated fashion and then switches off automatically. Hazards to hospital personnel or the patient are obviated due to the utilization of the normal mechanical devices that are also used during normal operation.

It is a further object of the invention to provide a hospital bed as described above, wherein a linear drive can be used as motor drive. Adequate driving conditions are achieved if the motor drive contains a worm gear pair in connection with a screw spindle. A gearing of this type has a practically independent lifting speed within the load range of interest during the lowering movement. The normal operating voltage, with which the motor drive usually operates, may correspond to the nominal voltage of the motor. It may lie in the range of 24 V_{eff} of full wave-rectified AC voltage. It may be desirable that the operating voltage for the emergency mode is also an extra-low safety voltage.

It is a further object of the invention to provide a hospital bed as described above, wherein very fast operation is achieved via use during emergency mode of a smoothed DC voltage that lies very close to the permissible maximum value for extra-low safety voltages. Since the motor merely needs to overcome the frictional losses in the lowering mode, the electric power of the emergency mode power supply can be kept very low. If the emergency mode power supply is switched on by means of change-over switches, the normal commercially available control can be equipped as desired. It suffices to electrically switch off the motor by means of the normal control in the emergency mode and connect the motor to the emergency mode power supply. Since the emergency mode is a lowering mode only, it suffices to provide only a single polarity.

The following description of the figures clarifies certain aspects for understanding the invention. A person skilled in the art is able to conventionally gather other details that are not described from the drawings that supplement the description of the figures in this respect. It is obvious that numerous modifications are possible.

The enclosed drawings are not necessarily drawn true to scale. Certain regions may be exaggerated in size to elucidate details. In addition, the drawings have been simplified and do not contain every detail that may be provided in practical embodiments. The terms top, bottom and front, rear or left and right refer to the normal operating position and terminology.

An embodiment example of the object of the invention is illustrated in the drawings.

Other objects and advantages of the invention will become apparent upon reading the following detailed description and upon reference to the drawings, in which:

### BRIEF DESCRIPTION OF THE DRAWINGS

FIG. 1 shows a schematic representation of a hospital bed according to the invention; and

FIG. 2 shows a basic circuit diagram of the hospital bed according to FIG. 1;

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

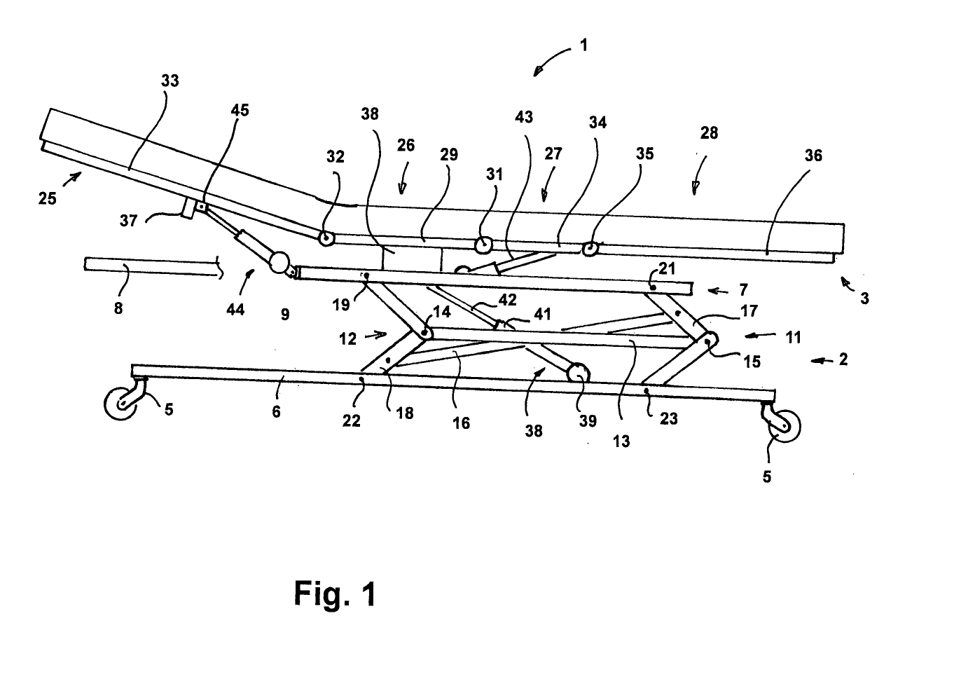

FIG. 1 shows a hospital bed 1 in the form of a highly simplified side view. The hospital bed 1 includes a lifter 2 that stands on the floor, as well as a bed frame 3 that is situated on said lifter and carries a mattress 4. The lifter 2 is composed of a lifter base 6 that stands on the floor with a total of four wheels 5 and a lifter head 7. The base 6 consists of a frame-like rectangular structure, wherein the steerable wheels 5 are fixed on the corners of the frame 6.

The lifter head 7 is realized in the form of a frame and is composed of two parallel longitudinal beams 8, of which only one is visible due to the perspective of the illustration, as well as crossbeams 9 that connect the longitudinal beams 8, one of which is visible in the sectioned region of the lifter head 7.

The lifter head 7 is connected to the floor frame 6 by a total of four toggle lever pairs, of which only the two toggle lever pairs 11 and 12 facing the observer are visible due to the side view. Two additional toggle lever pairs are concurrently situated behind the visible toggle lever pairs. The toggle lever pairs on each side are connected to one another by means of a horizontal coupling brace 13, as illustrated for the toggle lever pairs 11 and 12, wherein the horizontal coupling brace is hinged to the toggle joints 14 and 15 that connect the two toggle levers of the toggle lever pairs 11 and 12 to one another.

On each side, another oblique coupling brace 16 connects an upper toggle lever 17 of the toggle lever pair 11 on the foot side to a lower toggle lever 18 of the toggle lever pair 12 on the head side and is respectively hinged thereto. The coupling of the toggle lever pairs 11 and 12 between the longitudinal beams of the lifter head 7 and the floor frame 6 is schematically indicated in the form of hinge axes 19 and 21, as well as 22 and 23. A more detailed explanation of the lifter 2 is not essential to understanding the invention since the lifter 2 is not the object of the invention. The design and function of the lifter 2 is described in detail in German Patent DE 10 2004 019 144, which is herein incorporated by reference in its entirety, for all that it teaches without exclusion of any part thereof.

The bed frame 3 that carries the mattress 4 is composed of a back section 25, a central section 26, a thigh section 27, and a lower leg and leg section 28. The back section 25 refers to a region of the bed frame 3 on which the back and the head of the patient are situated in the natural posture of a patient lying in bed. The back section 25 may, if applicable, also feature a movable head section as is customarily provided on hospital beds.

The central section 26 features two parallel beams 29 that are arranged adjacent to one another in the longitudinal direction of the bed, wherein only the facing beam 29 is once again visible due to the illustration. The central section 26 transitions into a beam 33 of the back section 25 and a beam 34 of the thigh section 27 by means of hinges 31 and 32. Beams extending parallel and congruently to the hinges 31 and 32 and the beams 33 and 34 are also provided on the left side of the bed such that the bed frame 3 has an overall frame-like design.

On its end that lies opposite of the central section 26, the beam 34 features another hinge 35 for articulating a beam 36 to the beam 34. The beam 36 forms part of the lower leg and foot section 28. The beam 36 also has a counterpart on the left side of the bed.

The cited beams 29, 33, 34 and 36 are connected to one another by crossbraces to the degree required for reinforcement. One crossbrace 37 of these crossbraces is visible in the region of the back section 25. The hinge axes of the hinge joints 31, 32 and 35 are arranged pair-wise coaxially to one another on both sides of the bed. The two beams 29 of the central section 26 are connected to the lifter head 7 by means of a girder-like intermediate section 38.

Several electric linear drives are provided to move the individual parts of the bed 1. Each of the electric linear drives consists of an electric motor that conventionally drives a screw spindle via a worm gear pair. These drives include a drive 38 that is articulated to a crossmember (not shown) of the floor frame 6 on one end and in the head frame 7 on the other end. The motor 39, a guide tube 41 and a telescopic lifting tube 42 of the linear drive 38 are visible in the drawing. Another linear drive 43 of identical design extends between the lifter head 7 and the thigh section 27. A third drive 44 is hinged to the crossbeam 9 of the lifter head 7 on one end and to lugs 45 that are connected to the crossbrace 37 on the other end.

The distance between the lifter head 7 and the floor frame 6 can be varied by actuating the linear drive 38 as is common practice with hospital beds. The thigh section 27 can be moved from the horizontal position shown into a more or less upright position by actuating the drive 43, wherein the thigh section 27 pivots upward about the axes of the associated hinges 31. Parallelogram guides (not shown) ensure that the lower leg and foot section 28 remains more or less horizontal regardless of the pivoting position of the thigh section 27. The inclination of the back section 25 can be adjusted by switching on the drive 44.

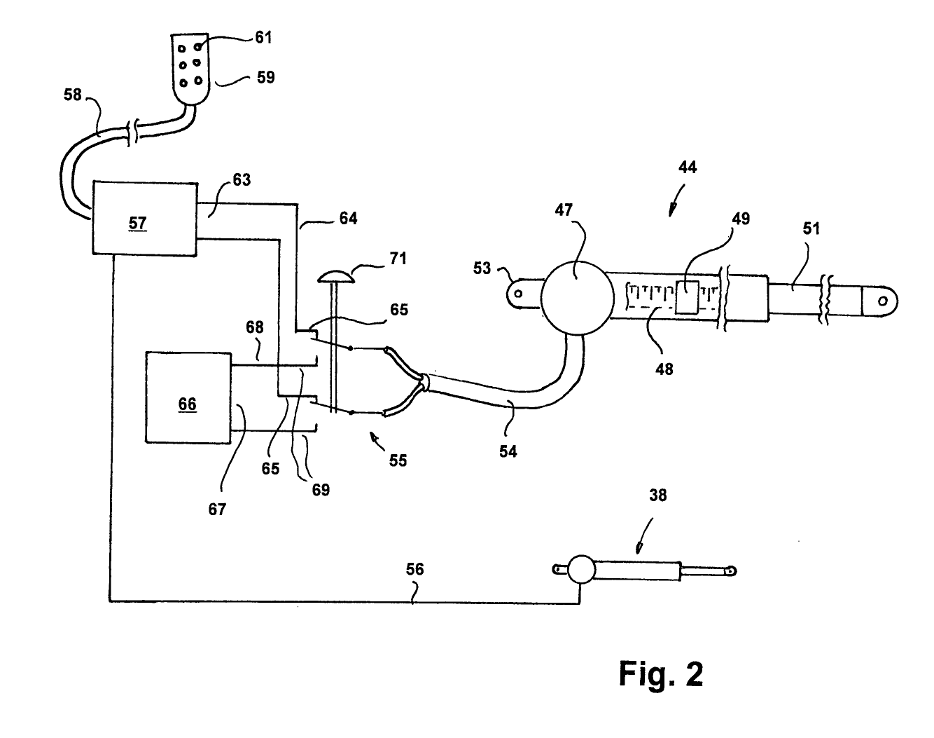

Referring now to FIG. 2, this figure shows the basic electric circuit diagram of the hospital bed 1 according to FIG. 1. This figure shows the drive 44 for moving the back section 25 and the drive 38 that is representative for the two drives 38 and 43 and serves for the height adjustment of the lifter 2.

As can be seen, the drive 44 is shown larger than the drive 38, merely due to the technical illustration, because the electric control essentially concerns the drive 44 for the back section 25. According to this figure, the drive 44 also features a housing 47 in which a motor in the form of a permanently excited DC motor is located. This motor conventionally drives a screw spindle that is indicated by broken lines at 48 via a worm gear pair. A threaded nut 49 that is connected to a lifting tube 51 in a tension-proof and compression-proof fashion, preferably only in a compression-proof fashion, turns on the screw spindle 48. A fork head 52 for connecting the lifting tube 51 to the lug 52 is located on the free end of the lifting tube 51. A fork head 53 on the motor housing 47 that lies opposite of the fork head 52 is articulated to the crossmember 9. A power supply cable 54 that is connected to a two-pole change-over switch 55 projects from the motor. The connecting line of the lifting motor 38 is schematically indicated by reference numeral 56.

A control 57 is provided for operating the hospital bed 1, i.e., the electric drives 38, 42, 44 situated therein, wherein a manually operated keypad 59 is connected to said control by means of a cable 58. The buttons 61 of the manually operated keypad 59 make it possible for the user to issue electrical commands that are evaluated in the control 57 and ensure that the motors are correspondingly acted upon with a current. The control 57 accordingly features an output 62, to which the line 56 is connected, as well as another (not-shown) output, to which the third motor is connected, for example, the motor 43. A two-pole power outlet 63 is connected to two break contacts 65 of the two-pole change-over switch 55 by means of two conductors 64.

In addition to the control 57 that simultaneously serves as power supply for the normal mode, another power supply 66 is provided that also features a two-pole output 67. The two-pole output 67 is connected to the main contacts 69 of the two-pole change-over switch 55 by means of lines 68.

The control 57, as well as the additional power supply 66, feature a power input (not shown), by means of which both are supplied by the line power. The electrical energy obtained from the line power is reduced, for example, to 24 V and full wave-rectified within the control 57. Consequently, the control 57 is able to deliver an output voltage in the form of a 24 V_{eff} DC voltage at it outputs 62 and 63. The polarity of the output voltage at the outputs 62 and 63 can be changed by means of components contained in the control 57. The user determines the corresponding polarity and the time at which the voltage appears at the respective output 62, 63, by pressing the corresponding buttons 61 of the keypad 59.

The hospital bed functions flow from the design features discussed above. For example, if the user wishes to adjust the height of the hospital bed 1, in the sense of an increased bed height, he actuates, for example, the right button 61 in the lower row of the manually operated keypad 59. The electric signal thereby generated is evaluated by the control 57 that then makes available the 24 V supply voltage at the output 62 with a polarity that is chosen such that the driving motor 39 of the linear drive 38 extends the lifting tube 42. The extension movement of the lifting tube 42 takes place as long as the user presses the corresponding button 61. As soon as the button 61 is released, the control switches off the voltage at the output 62, and the linear drive 38 stops. Since the worm gear pair is self-locking, the height of the bed no longer changes after the button 61 is released.

If the user wishes to reduce the height of the bed, he pushes the button 61 on the left side in the lower row. The control 57 then once again switches the supply voltage to the output 62, but with a reversed polarity relative to the previous operation. The motor 39 now runs in the opposite direction and retracts the lifting tube 42 by means of the worm gear pair and the screw spindle.

Once the corresponding button 61 is released, the control 57 switches off the supply voltage at the output 62.

The user is able to similarly activate the linear drive 44 for the back section by pushing the button 61 in the upper row. For example, a supply voltage of 24 V appears at the output 63 when the right upper button 61 is pressed. The voltage is sent to the motor of the drive 44 via the break contacts 65 of the change-over switch 55. The polarity of the voltage is such that the motor 47 extends the lifting tube 51, and the back section 25 is additionally moved upward from the respective position into an upright position due to the mechanical connections. The movement is stopped by releasing the corresponding button.

When pressing the left button 61 in the upper row, the back section 25 is moved in the sense of lowering until the user again releases the corresponding button.

The output voltage at the outputs 62 and 63 is chosen such that the respective bed section moves quickly, but not excessively fast so that the patient does not experience insecurity. An excessively fast movement would also create problems during the correct positioning.

In case of an emergency with a collapsed patient, the normal speed can result in too much delay in the back section 25 being returned from a significantly upright position into the horizontal position, in which the collapsed patient can be resuscitated. Should the patient collapse while the back section 25 is in a significantly upright position, the hospital personnel have the option of actuating the two-pole change-over switch 55 with an actuating button 71. The change-over switch is, thus, transferred from its idle position shown into the change-over position. This means that the motor 47 of the linear drive 44 is disconnected from the output 63 of the control 57 and instead connected to the output 67 of the power supply 66 that continuously delivers a voltage. The continuously delivered output voltage of the power supply 66 may be, for example, at twice the output voltage delivered by the control 57. The polarity is chosen such that the back section 25 can only move downward.

Wherein the actuating button 71 is pressed, the motor 47 is connected to the power supply 66 that delivers twice the voltage such that the permanently excited DC motor now runs at twice the speed relative to the normal operation by means of the control 57. The back section 25 therefore is lowered with a significantly higher speed. The back section consequently can also be lowered from the highest pivoting position more quickly than in instances in which the back section is lowered by disengaging the gearing in the linear drive 44.

The significant advantage of the electric actuation in the emergency mode can be seen in that hospital personnel no longer need to intervene physically such that neither the patient nor hospital personnel are subject to potential accidents or hazards. Through the use of internal limit switches on the linear drives, the emergency lowering mode is also automatically stopped as soon as the drive has reached its end position that corresponds to the horizontal position of the back section.

The output voltage of the additional power supply 66 is advantageously chosen such that it is also considered an extra-low safety voltage that does not require additional insulation measures. For clarity, the additional power supply 66 is illustrated in the form of a separate arrangement in FIG. 2. A person skilled in the art can easily see that the function of the additional power supply 66 can also be realized directly within the control 57. The advantage of the separate power supply 66 can be seen in that it can be additionally supplied into existing systems at any time in this form without having to modify the control 57.

Although the aforementioned embodiment was described as using a two-pole change-over switch, it is also possible to use a one-pole change-over switch if a corresponding galvanic separation is provided.

It would also be conceivable to realize the emergency mode in such a way that the additional power supply does not make available the complete increased voltage, but only an additional voltage that is added to the output voltage of the control at the output 67 with appropriate polarity. In any case, the motor responsible for the drive of the back section 33 is supplied with a voltage in the emergency mode that is significantly higher than the voltage in the normal mode. Due to the higher voltage, the motor runs at a higher speed such that the back section 33 can be quickly lowered.

The additional power supply 66 does not require a particularly large electric line because only the internal friction of the drive system need be overcome during the lowering mode, but the weight of the patient need not be lifted.

It will be appreciated that the foregoing description provides examples of the disclosed system and the use thereof. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1-10. (canceled)

11. An electrically adjustable hospital bed for attaining a user-selected position and enabling rapid return to a horizontal position, comprising:
a floor-based lifter having a vertical length and which is adjustable with respect to its vertical length;
a bed frame that is arranged on the lifter and divided into multiple sections including:
a central section that is connected to the lifter; and
an upper section that is articulated to the central section; and
a motor drive coupled to the upper section to raise or lower the upper section, having a power supply arrangement for the motor drive adapted to be switched such that the motor drive is operated with a normal operating voltage in a normal mode and the motor drive is supplied with an operating voltage that lies above the normal operating voltage in case of an emergency to lower the upper section.

12. A hospital bed according to claim 11, wherein the motor drive consists of a linear drive.

13. A hospital bed according to claim 11, wherein the motor drive comprises a screw spindle that is driven by means of a worm gear pair.

14. A hospital bed according to claim 11, wherein the electric motor consists of a permanently excited DC motor.

15. A hospital bed according to claim 11, wherein the normal operating voltage corresponds to the nominal voltage of the motor.

16. A hospital bed according to claim 11, wherein the normal operating voltage is 24 V_{eff}.

17. A hospital bed according to claim 11, wherein the operating voltage that lies above the normal operating voltage is an extra-low safety voltage.

18. A hospital bed according to claim 11, wherein the operating voltage that lies above the normal operating voltage has a residual ripple of less than 10%, and that has peak values meeting the conditions of an extra-low safety voltage.

19. A hospital bed according to claim 11, wherein the power supply is configured such that the corresponding motor drive is disconnected from the output of a power supply, to which it is connected in the normal mode, in case of an emergency and instead connected to a power supply for the emergency mode.

20. A hospital bed according to claim 11, wherein the power supply is configured such that only the lowering mode can be realized with an operating voltage that lies above the normal operating voltage.
